(19) United States
(12) Patent Application Publication
(10) Pub. No.: US 2024/0350948 A1
(43) Pub. Date: Oct. 24, 2024

(54) WATER PURIFIER AND WATER SUPPLY COMPONENT

(71) Applicant: Qingdao Ecopure Filter Co., Ltd., Qingdao (CN)

(72) Inventor: Zhibin Zou, Qingdao (CN)

(73) Assignee: Qingdao Ecopure Filter Co., Ltd., Qingdao (CN)

(21) Appl. No.: 18/628,056

(22) Filed: Apr. 5, 2024

(30) Foreign Application Priority Data
Apr. 18, 2023 (CN) 2023104186901
Apr. 18, 2023 (CN) 2023208629247
Apr. 18, 2023 (CN) 2023208773498
Aug. 22, 2023 (CN) 2023222568168
Aug. 22, 2023 (CN) 2023222569635

(51) Int. Cl. B01D 35/26; B01D 35/147; C02F 1/00; C02F 1/32

(52) U.S. Cl. CPC B01D 35/26; B01D 35/1475; C02F 1/001; C02F 1/008; C02F 1/32; B01D 2201/167; B01D 2201/305; C02F 2201/005; C02F 2303/04

(57) ABSTRACT

In various aspects, a water supply assembly comprises a water assembly housing, a water pump positioned within the water assembly housing and comprising a water pump inlet and a water pump outlet, a water inlet and a water outlet, and a filter element fluidly coupled to the water pump. The filter element is positioned within the water assembly housing along a water flow path between the water pump outlet and the water outlet and the water inlet is positioned along the water flow path upstream of the water pump inlet. The water supply assembly may be mounted on a water supply tank in a water purifier.

### CROSS-REFERENCE TO RELATED APPLICATIONS

This application claims the benefit of and priority to CN application No. 2023208773498, filed on Apr. 18, 2023, CN application No. 2023104186901, filed on Apr. 18, 2023, CN application No. 2023222568168, filed on Aug. 22, 2023, CN application No. 2023222569635, filed on Aug. 22, 2023, and CN application No. 2023208629247, filed on Apr. 18, 2023, each of which is hereby incorporated by reference in its entirety.

### BACKGROUND

In various locations around the world, the quality of tap water is poor due to the addition of chemicals or lack of water purification technology. When consumers drink tap water directly, harmful substances in tap water may enter the consumer's body. Therefore, water purification equipment is becoming more and more popular.

Some existing water purification equipment water purification equipment includes a water tank and a water supply component and is configured to be placed on a table or countertop. The water supply component provides power through a water pump to control the raw water in the water tank to flow through the filter element and be discharged from the outlet. The equipment commonly requires that the pump and the filter element be independently installed in the water purification equipment, which can result in a complicated flow path for the water and/or complicated assembly.

Moreover, when the water purification equipment and the water pump are turned on, the water in the water tank is pressurized from the inlet end through the water pump to the front end of the filter element. Due to the certain resistance of the filter element itself to the water flow, a certain water pressure will be generated between the water pump and the filter element, and the water flow will eventually flow out of the outlet through the filter element. When the water pump is turned off, there is still water pressure in the upstream pipeline because the water pressure between the water pump and the filter element cannot be released immediately. Under the action of water pressure, the water in the upstream pipeline flows to the outlet end, causing water to continuously drip from the outlet of the water purification equipment after shutdown, which may cause problems for some users.

In order to prevent dripping water, conventional water purification equipment may include a switch solenoid valve in the upper water pipeline which is closed at the same time as the water pump. However, back pressure on the solenoid valve may cause the solenoid valve to fail to an open configuration, causing the entire water pipeline to be pressurized and rendering the system unable to discharge water.

Accordingly, there remains a need for alternative water purification equipment.

### SUMMARY

This summary is meant to provide various examples of the aspects disclosed herein and is not intended to be limiting the scope of the disclosure in any way. For example, any feature included in an example of this summary is not required by the claims, unless the claims explicitly recite the feature. Also, the features, components, steps, concepts, etc. described in the examples in this summary and elsewhere in this disclosure can be combined in a variety of ways. Various features and steps as described elsewhere in this disclosure may be included in the examples summarized here.

In aspects of the present application, a water purifier comprises a water tank comprising a mounting portion and a receiving portion for storing water and a water supply assembly removably mounted to the mounting portion of the water tank. The water supply assembly comprises a water inlet in fluid communication with the receiving portion of the water tank, a water pump comprising a water pump inlet and a water pump outlet, a filter element fluidly coupled to the water pump, a water outlet positioned along the water flow path downstream of the water pump outlet, and a water assembly housing in which the water pump and filter element are positioned. The filter element is positioned along a water flow path between the water outlet and the water pump outlet.

In aspects, the water inlet and the water outlet may be disposed in an upper part of the water assembly housing. The filter element may be positioned below the water pump in the water assembly housing. In aspects disclosed herein, a water tank cover is positioned over an upper opening of the water tank and at least partially covers the water supply assembly. A sterilization device may be disposed on a lower surface of the water tank cover.

In aspects of the disclosure, the mounting portion may comprise side walls defining, with the water tank, a mounting space for the water supply assembly. The water supply assembly may be at least partially supported by the side walls, by an edge of the water tank, and/or the water by a bottom of the water tank.

In any of the aspects disclosed herein, the water purifier may further comprise a sterilization device. The sterilization device may be present on a lower surface of the water tank cover or within the water supply assembly.

In aspects, a filter element for a water purifier comprises a filter element housing and a filter element body. A latching member is provided on the filter element housing and comprises a latching portion having a first latching structure. The latching portion and a side wall of the filter element housing define a gap therebetween and the latching portion can be offset and reset in a direction of the side wall of the filter element housing.

The filter element may further comprise a concession groove on the filter element housing corresponding to the latching member. The latching member may further comprise a connecting portion configured to couple the latching portion to the filter element housing. The connecting portion may be provided on the side wall of the filter element housing near an end of the filter element housing.

In various aspects herein, a water supply assembly comprises a water assembly housing, a water pump positioned within the water assembly housing and comprising a water pump inlet and a water pump outlet, a water inlet and a water outlet, and a filter element fluidly coupled to the water pump. The filter element is positioned within the water assembly housing along a water flow path between the water pump outlet and the water outlet and the water inlet is positioned along the water flow path upstream of the water pump inlet.

The water inlet and the water outlet may be disposed in an upper part of the water assembly housing. The filter element may be snap-connected to the water assembly housing. In aspects, the water pump and the filter element are in a stacked configuration.

In aspects, the water supply assembly further includes a control module. The control module may be positioned above the water pump within the water assembly housing. The water supply assembly may additionally include a power supply configured to supply power to the water pump.

### BRIEF DESCRIPTION OF THE DRAWINGS

To further clarify various aspects of the present disclosure, a more particular description of certain examples and implementations will be made by reference to various aspects of the appended drawings. These drawings depict only example implementations of the present disclosure and are not to be considered as limiting the scope of the disclosure. Moreover, while the FIGS. may be drawn to scale for some aspects of the present disclosure, the FIGS. are not necessarily drawn to scale for all aspects described herein. Examples and other features and advantages of the present disclosure will be described and explained with additional specificity and detail through the use of the accompanying drawings, in which:

FIG. 1 is an illustration of an example water supply assembly in accordance with one or more aspects described herein;

FIG. 2 is a schematic diagram of the example water supply assembly shown in FIG. 1;

FIG. 3 is an illustration of another example water supply assembly in accordance with one or more aspects described herein;

FIG. 4 is a schematic diagram of the example water supply assembly shown in FIG. 3;

FIG. 5 is an illustration of another example water supply assembly in accordance with one or more aspects described herein;

FIG. 6 is a schematic diagram of the example water supply assembly shown in FIG. 5;

FIG. 7 is an illustration of another example water supply assembly in accordance with one or more aspects described herein;

FIG. 8 is a schematic diagram of the example water supply assembly shown in FIG. 7;

FIG. 9 is an illustration of an example water supply assembly including a sterilization device in accordance with one or more aspects described herein;

FIG. 10 is a sectional view of an example water supply assembly according to one or more aspects described herein;

FIG. 11 is an illustration of the water supply assembly according to one or more aspects described herein;

FIG. 12 is an illustration of the assembly of water supply assembly and the water tank cover according to one or more aspects described herein;

FIG. 13 is an illustration of the sterilization device and a portion of the upper water pipeline according to one or more aspects described herein;

FIG. 14 is a schematic diagram of a water purifier described according to one or more aspects described herein;

FIG. 15 is a top view of FIG. 14;

FIG. 16 is an exploded view of a water purifier according to one or more aspects described herein;

FIG. 17 is a schematic diagram of the water supply assembly of a water purifier according to one or more aspects described herein;

FIG. 18 is a schematic diagram of the water tank of a water purifier according to one or more aspects described herein;

FIG. 19 is a sectional view along line A-A in FIG. 18;

FIG. 20 is a top view of the water tank of FIG. 18;

FIG. 21 is a schematic diagram of the water pump battery assembled in accordance with one or more aspects shown and described herein;

FIG. 22 is a top view of FIG. 21;

FIG. 23 is a bottom view of FIG. 21;

FIG. 24 is a schematic diagram of the assembly of the filter element and the filter element joint according to one or more aspects described herein;

FIG. 25 is a top view of FIG. 24;

FIG. 26 is a sectional view along line A-A in FIG. 25;

FIG. 27 is a sectional view along line B-B in FIG. 25;

FIG. 28 is a schematic diagram of the waterway connection according to one or more aspects described herein;

FIG. 29 is a schematic diagram of the structure of the filter element according to one or more aspects described herein;

FIG. 30 is a schematic diagram of another view according to one or more aspects described herein;

FIG. 31 is a diagram of the water assembly housing according to one or more aspects described herein;

FIG. 32 is a longitudinal sectional view of FIG. 31 according to one or more aspects described herein;

FIG. 33 is a longitudinal sectional view of the filter element and the water assembly housing according to one or more aspects described herein;

FIG. 34 is a schematic diagram of an alternative internal structure of the water intake in FIG. 17 according to one or more aspects described herein;

FIG. 35 is a front view of a water uptake device according to one or more aspects described herein;

FIG. 36 is a sectional view along line A-A of FIG. 35;

FIG. 37 is an illustration of a water supply tank according to one or more aspects described herein; and

FIG. 38 is another view of a water uptake device according to one or more aspects described herein.

### DETAILED DESCRIPTION

The following description refers to the accompanying drawings, which illustrate example implementations and various aspects of the present disclosure. Other implementations having different structures and operation do not depart from the scope of the present disclosure.

It should be noted that, in the description of the present application, terms such as “up,” “down,” “left,” “right,” “vertical,” “horizontal,” “inside,” and “outside” indicate directions or are terms of positional relationship that are based on the direction or positional relationship shown in the drawings, which are only for the convenience of description, and do not indicate or imply that the device or element must have a specific orientation, be constructed or operated in a specific orientation, and therefore cannot be understood. In addition, the terms “first,” “second,” and the like are used for descriptive purposes only and should not be understood as indicating or implying relative importance. Furthermore, the term “plurality” means two or more, unless otherwise specifically defined.

In the present disclosure, unless otherwise specified and so limited, terms such as “installation,” “connection,” and “fixation” should be understood in a broad sense. For example, a connection can be a fixed connection, a detachable connection, an integration, a mechanical connection, an electrical connection, a director connection or indirect connection through an intermediary, or an internal communication of two components or the interaction between two components. Those of ordinary skill in the art can understand the specific meanings of the above terms in the present application according to specific aspects described herein.

Disclosed herein are water supply assemblies, filter elements, and water purification devices including the same. In various aspects, the water supply assembly comprises a water assembly housing, a water pump positioned within the water assembly housing and comprising a water pump inlet and a water pump outlet, a water inlet and a water outlet, and a filter element fluidly coupled to the water pump. The filter element is positioned within the water assembly housing along a water flow path between the water pump outlet and the water outlet and the water inlet is positioned along the water flow path upstream of the water pump inlet.

### Water Supply Assemblies

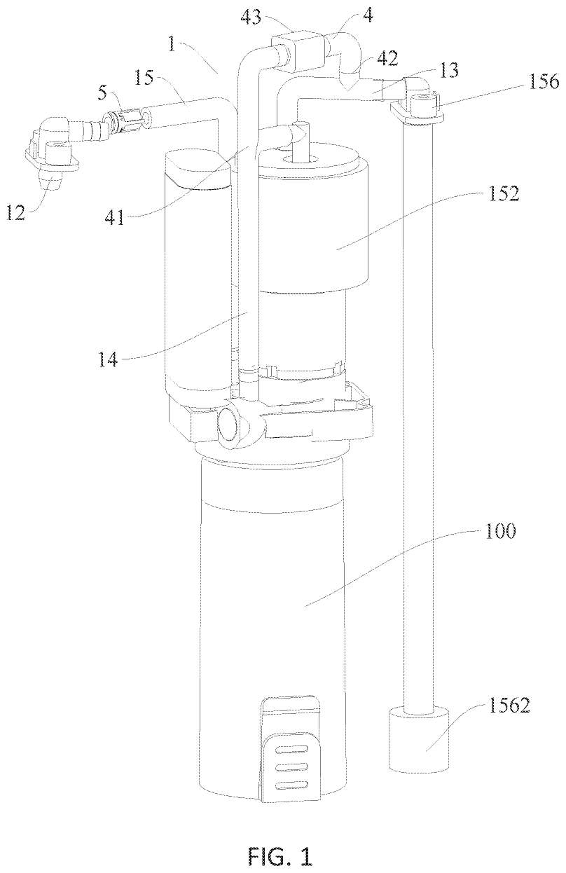

In various aspects and as shown in FIGS. 1-8, a water supply assembly includes a water supply line 1, a water pump 152, a filter element 100, and a pressure relief pipeline 4. The water supply line 1 defines a water flow path that extends from a water inlet 156 to a water outlet 12 of the water supply line 1. The water inlet 156 is fluidly coupled to a water source (not shown). The water source can be, for example, a water tank containing raw (e.g., unfiltered) water. In such configurations, the water inlet 156 is configured to take water in from the water tank into the water supply line 1, such as through a suction pipe and filter head. Alternatively, the water source may be a pressure-free water supply pipeline. In such configurations, an outlet of the pressure-free water supply pipeline may be directly connected to the water inlet 156 to provide water through the water inlet 156 to the water supply line 1. In still other aspects, the water source may be a container or scene for raw (e.g., unfiltered) water in any space or area (such as outdoor rivers, lakes, ponds, streams, etc.), and the water inlet 156 sucks raw water into the water supply line 1 from an appropriate position.

The water outlet 12 is used to dispense filtered water from water supply line 1. The water outlet 12 is generally connected to or includes a water outlet nozzle. The water pump 152 and the filter element 100 are positioned along the water flow path defined by the water supply line 1, with the water pump 152 positioned between the filter element 100 and the water inlet 156 of the water supply line 1. That is, between the water inlet 156 and the water outlet 12, the water pump 152 and the filter element 100 are sequentially arranged. In aspects, other components may additionally be located along the water flow path, including, but not limited to, water sterilizing devices (described below). In various aspects described herein, the filter element 100 is located on the head of the water pump 152 and filters the water passing through it. The water pump 152 generates water power to move the water from the water inlet 156 of the water supply line 1, through the filter element 100, and to the water outlet 12.

The pressure relief pipeline 4 is also connected to the water supply line 1. In aspects, the pressure relief pipeline 4 is connected in parallel with the water supply line 1. The pressure relief pipeline 4 has a first configuration (e.g., a cut-off state) and a second configuration (e.g., a pressure relief state). The pressure relief pipeline 4 is configured to be changed between the first configuration and the second configuration through a valve, such as an electronically controlled valve 43 fluidly coupled to the pressure relief pipeline. In various aspects, the pressure relief pipeline 4 is in the first configuration when the water pump 152 is turned on so that the water in the water supply line 1 flows through the water outlet 12 to provide water output from the water supply component. In various aspects, the pressure relief pipeline 4 is in the second configuration when the water pump 152 is turned off to relieve the pressure in the water supply line 1 so that water does not drip from the water outlet 12 of the water supply line 1.

In various aspects of the disclosure, the electronically controlled valve 43 is controlled to close to put the pressure relief pipeline 4 in the off state, and the electronically controlled valve 43 is controlled to open to put the pressure relief pipeline 4 in the pressure relief state. The first end 41 of the pressure relief pipeline 4 is connected to the water supply line 1 between the water pump 152 and the filter element 100, and the second end of the pressure relief pipeline 4 is connected to the water supply line 1 between the water inlet 156 and the water pump 152 or the second end 42 of the pressure relief pipeline 4 communicates with a water source. In some aspects, the electronically controlled valve 43 is a solenoid valve. Alternatively, the electronically controlled valve 43 may be an electric valve, and any type of valve that can be powered on and off is within the scope of protection of the present application.

The first end 41 of the pressure relief pipeline 4 is connected to the water supply line 1 between the filter element 100 and the water outlet 12, and the second end of the pressure relief pipeline 4 is connected to the water supply line 1 between the water inlet 156 and the water pump 152 or the second end 42 of the pressure relief pipeline 4 communicates with the water source. The second end 42 of the pressure relief pipeline 4 communicates with the water source specifically includes the following three situations: taking the water source as the raw water contained in the water tank as an example, the second end 42 of the pressure relief pipeline 4 can be located above the water tank, or the second end 42 of the pressure relief pipeline can penetrate into the water tank, or the second end 42 of the pressure relief pipeline is connected to the water tank wall, and the water tank wall has a drainage hole, and the second end 42 of the pressure relief pipeline is connected to the drainage hole.

In aspects of the present disclosure, the water supply assembly also includes a one-way valve 5, which can enable a reduction in, or elimination of, dripping. The one-way valve 5 is provided on the water supply line 1 and is located between the filter element 100 and the water outlet 12. Since the one-way valve 5 itself has a certain conduction pressure, under normal working conditions, it can only be turned on when there is a certain pressure upstream of the one-way valve 5, that is, when the water pump 152 is closed, the pressure upstream of the one-way valve 5 is reduced to the conduction pressure of the one-way valve 5, and the water outlet 12 can stop the water output, and the remaining water in the water supply line 1 is discharged through the pressure relief pipeline 4, which can make the water outlet 12 stop the water output as soon as possible and avoid dripping.

In order to ensure the maximum effect of the one-way valve 5, the one-way valve 5 is positioned adjacent to the water outlet 12. When the device adjacent to the water outlet 12 is a filtering device, the one-way valve 5 may be located between the filtering device and the water outlet 12. When the device adjacent to the water outlet 12 is a sterilization device, the one-way valve 5 may be located between the sterilization device and the water outlet 12.

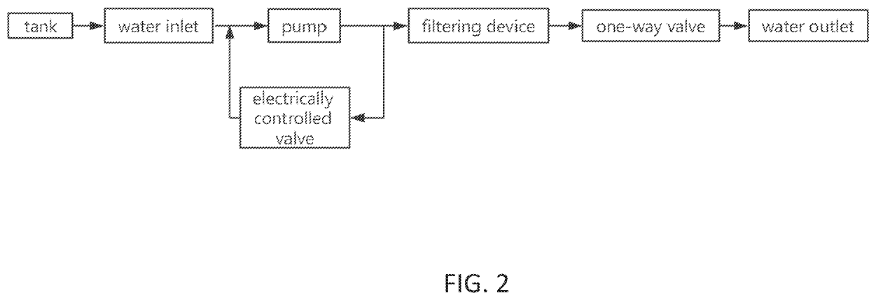

As shown in FIGS. 1 and 2, the filter element 100 is located downstream of the water pump 152, and the first end 41 of the pressure relief pipeline 4 is connected to the water supply line 1 between the water pump 152 and the filter element 100 to relieve the water pressure between the water pump 152 and the filter element 100 to avoid water dripping from the water outlet 12. By cooperating with the one-way valve 5 on the upstream water supply line 1 downstream of the pressure relief pipeline 4, the water outlet 12 can be stopped as soon as possible and dripping from the water outlet 12 can be avoided or reduced.

In aspects of the disclosure, the water supply line 1 includes a first upper water pipe section 13 located between the water inlet 156 and the water pump 152, a second upper water pipe section 14 located between the water pump 152 and the filter element 100, and a third upper water pipe section 15 located between the filter element 100 and the water outlet 12. The first end 41 of the pressure relief pipeline 4 is connected to the second upper water pipe section 14, and the second end 42 of the pressure relief pipeline 4 is connected to the first upper water pipe section 13.

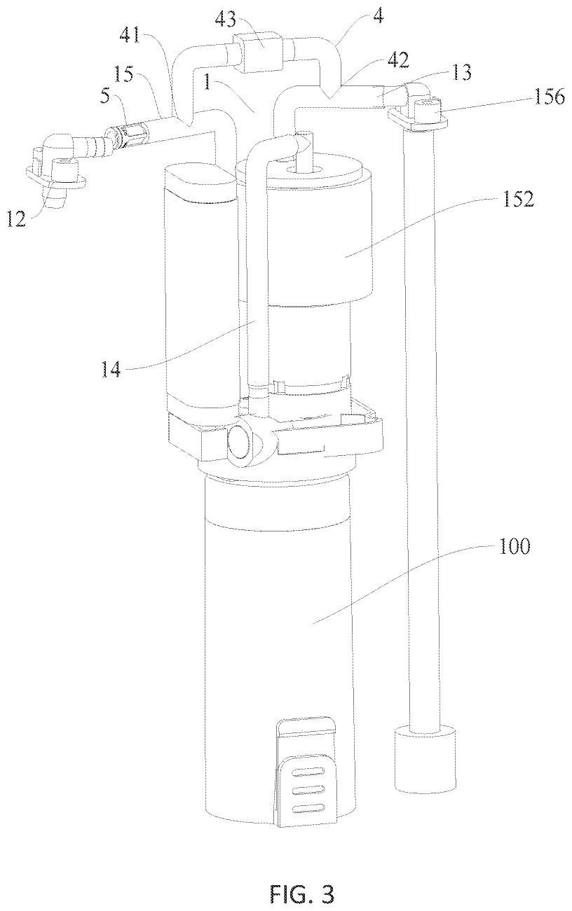

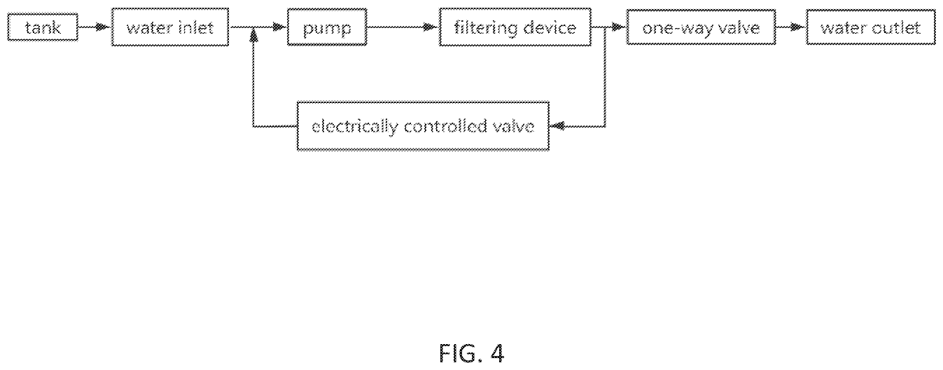

Turning now to FIGS. 3 and 4, an alternative configuration for a water supply assembly is shown. Although similar to the water supply assembly depicted in FIGS. 1 and 2, in aspects, the filter element 100 is located downstream of the water pump 152, and the first end 41 of the pressure relief pipeline 4 is fluidly coupled to the water supply line 1 between the filter element 100 and the water outlet 12 to remove the water pressure between the filter element 100 and the water outlet 12. The water between the filter element 100 and the water outlet 12 can be removed from the pressure relief pipeline 4 to reduce or even prevent water from dripping from the water outlet 12. By cooperating with the one-way valve 5 on the water supply line 1 downstream of the pressure relief pipeline 4, the water outlet 12 can be stopped as soon as possible and dripping from the water outlet 12 can be reduced or eliminated.

In aspects of the disclosure, the water supply line 1 includes a first upper water pipe section 13 located between the water inlet 156 and the water pump 152, a second upper water pipe section 14 located between the water pump 152 and the filter element 100, and a third upper water pipe section 15 located between the filter element 100 and the water outlet 12. The first end 41 of the pressure relief pipeline 4 is connected to the third upper water pipe section 15, and the second end 42 of the pressure relief pipeline 4 is connected to the first upper water pipe section 13.

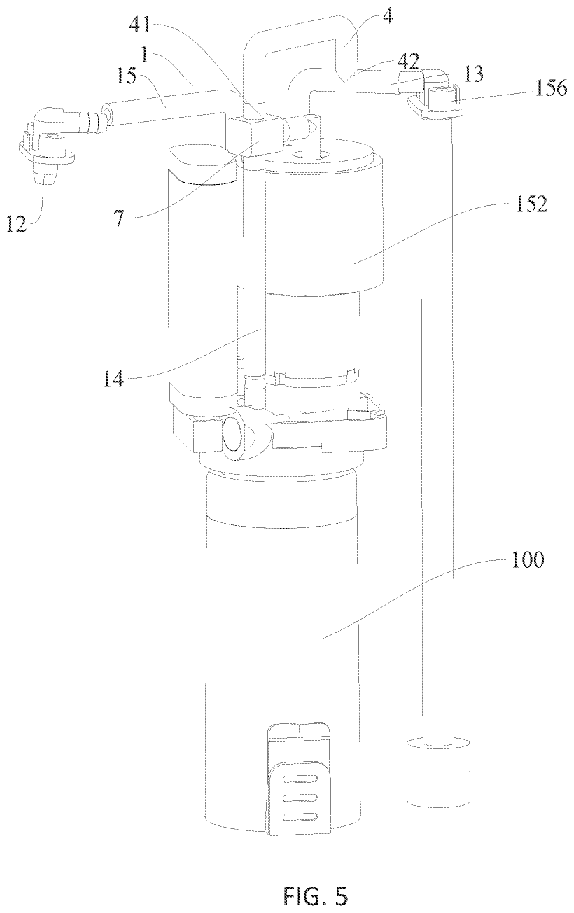

Turning now to FIGS. 5-8, in some aspects of the disclosure, the water supply line 1 is connected to the pressure relief pipeline 4 through an electronic control valve in the form of a three-way solenoid valve 7. Alternatively, the electric control valve may be a three-way electric valve, and it is contemplated that the electronic control valve can be any type of three-way valve that can achieve power control on and off.

The three-way solenoid valve 7 is configured to turn on the water supply line 1 and cut off the pressure relief pipeline 4 when the water pump 152 is turned on, and turn off the water supply line 1 and turn on the pressure relief pipeline 4 when the water pump 152 is closed. When the water pump 152 is turned on, the water supply line 1 is in the conductive state, and the pressure relief pipeline 4 is in the cut-off state. Therefore, the water in the water supply line 1 flows out through the water outlet 12 output water from the water supply line 1. The pressure relief pipeline 4 does not affect the water output. When the water pump 152 is closed, the water supply line 1 is in the cut-off state, and the pressure relief pipeline 4 is in the pressure relief state to relieve the pressure of the water supply line 1 through the pressure relief pipeline 4. When the water pump 152 is closed, the water supply line 1 is cut off, and the water supply line 1 releases pressure through the pressure relief pipeline 4 so that water does not drip from the water outlet 12 of the water supply line 1.

In various aspects, the three-way solenoid valve 7 is provided between the water pump 152 and the filter element 100, or the three-way solenoid valve 7 is provided between the filter element 100 and the water outlet 12. The three-way solenoid valve 7 is connected to the first end 41 of the pressure relief pipeline 4, and the second end 42 of the pressure relief pipeline 4 is connected between the water inlet 156 and the water pump 152, or the second end 42 of the pressure relief pipeline 4 communicates with a water source.

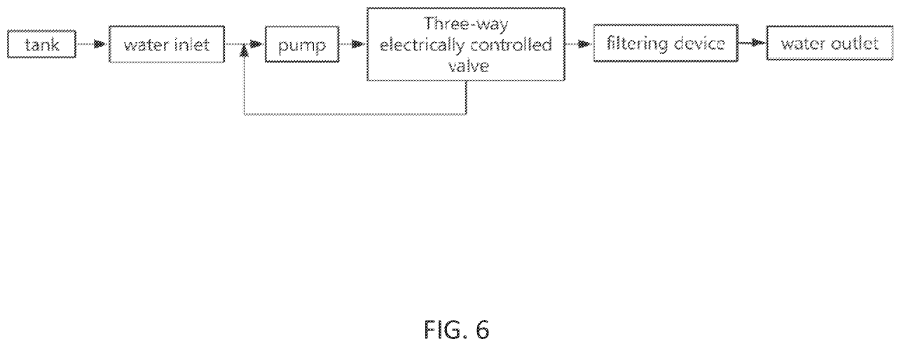

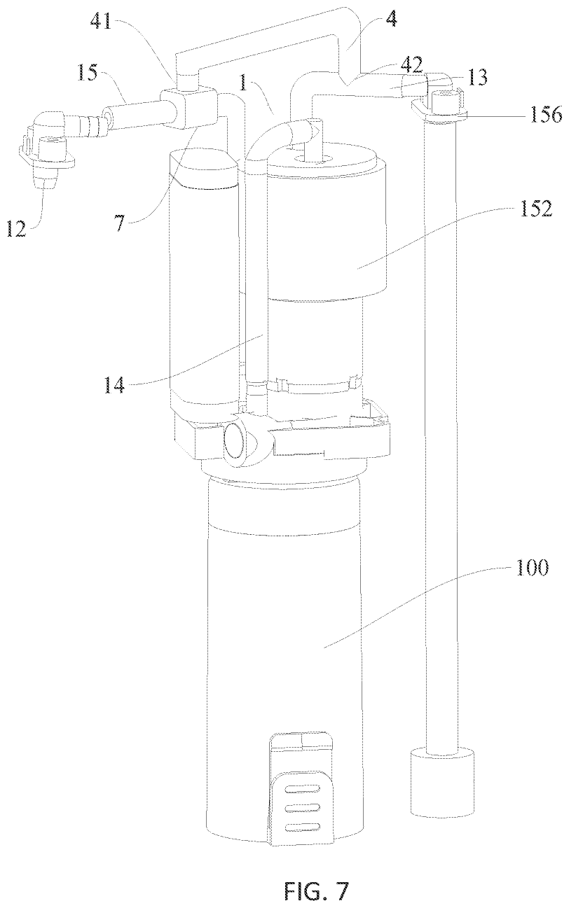

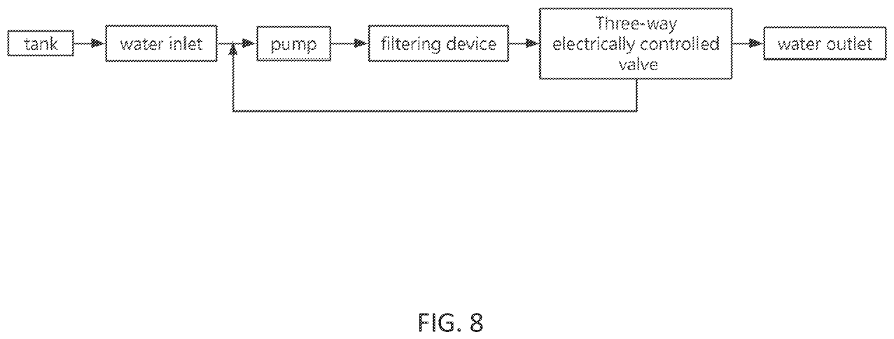

As shown in FIGS. 5 and 6, the filter element 100 is located downstream of the water pump 152, and the three-way solenoid valve 7 is connected to the water supply line 1 between the water pump 152 and the filter element 100. That is, the three-way solenoid valve 7 is connected to the second upper water pipe section 14. In FIGS. 7 and 8, the filter element 100 is located downstream of the water pump 152, and the three-way solenoid valve 7 is connected to the water supply line 1 between the filter element 100 and the water outlet 12. That is, the three-way solenoid valve 7 is connected to the third upper water pipe section 15.

By using the three-way solenoid valve 7, on the one hand, the water supply line 1 can be cut off to avoid dripping water, and on the other hand, the pressure relief pipeline 4 can be turned on while the water supply line 1 is cut off, to prevent the back pressure of the three-way solenoid valve 7 from becoming too large to turn on the water supply line 1, and to avoid water stagnation and inability to discharge water in the water pipeline. In some other aspects of the disclosure, the three-way solenoid valve 7 is connected to the second end 42 of the pressure relief pipeline 4.

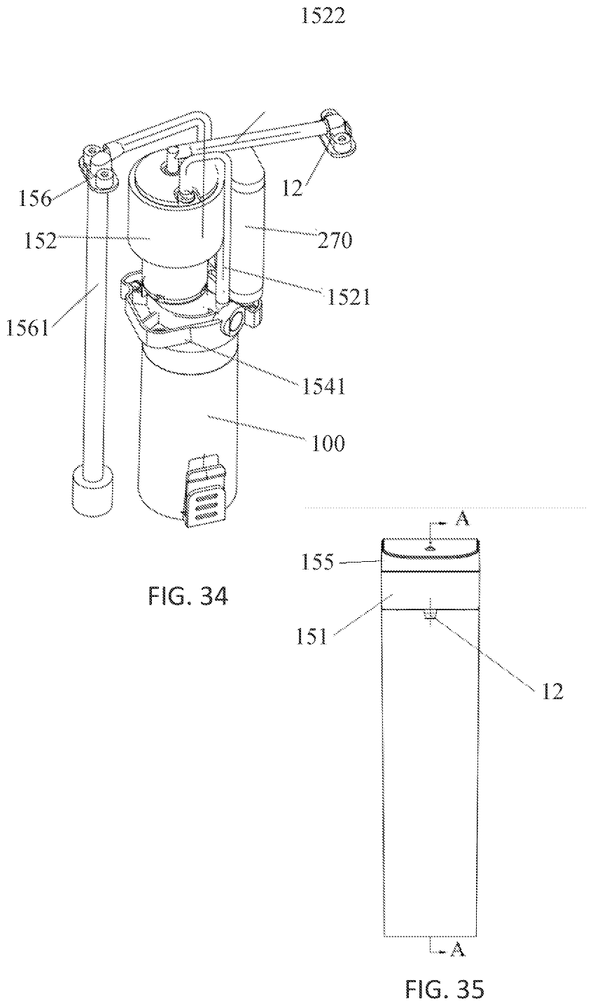

FIG. 34 illustrates yet another configuration of a water supply assembly in accordance with various aspects of the present disclosure. Similar to the other water supply assemblies shown and described herein, the water supply assembly in FIG. 34 includes a water pump 152, a water outlet 12, a water inlet 156, and a filter element 100. The water inlet 156 is connected to the suction pipe 1561. The water pump 152 is connected to the water pump inlet 1521 and the water pump outlet 1522. In FIG. 34, the water inlet of the filter element 100 is connected to the water inlet 156, the water outlet of the filter element 100 is connected to the water pump inlet 1521, and the water pump outlet 1522 is connected to the water outlet 12. The water inlet 156 and water outlet 12 are both located on the upper part of the water supply assembly, which may provide sufficient container placement space for receiving purified water and make connection of water pipes easier. It is contemplated that the water inlet and water outlet may be configured in other ways. For example, the water outlet may be positioned on the upper part of the water supply assembly for the user to receive water while the water inlet is positioned at the bottom of the water source and a water pipe is laid at the bottom of the water source to connect with the water pump module. This setting method of the inlet and water outlet nozzles can ensure the full utilization of water (especially when the water is set in a fixed container), and the water pipe is not exposed, with a simple appearance.

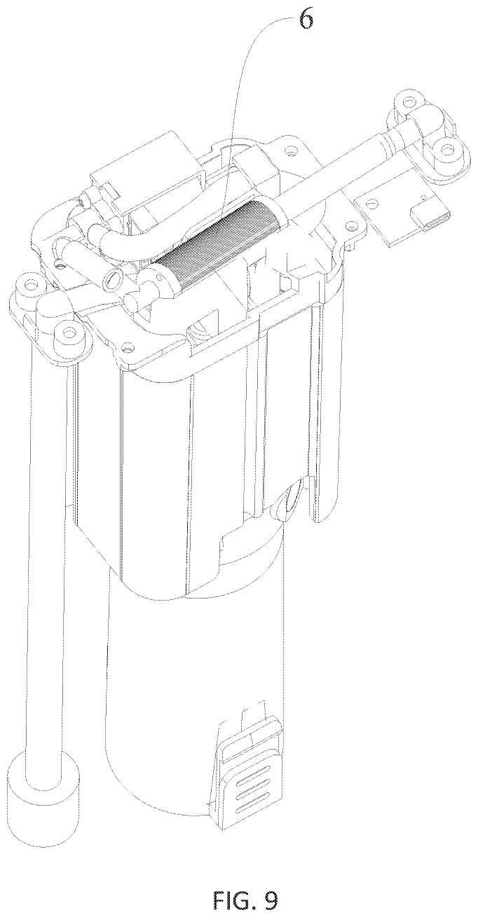

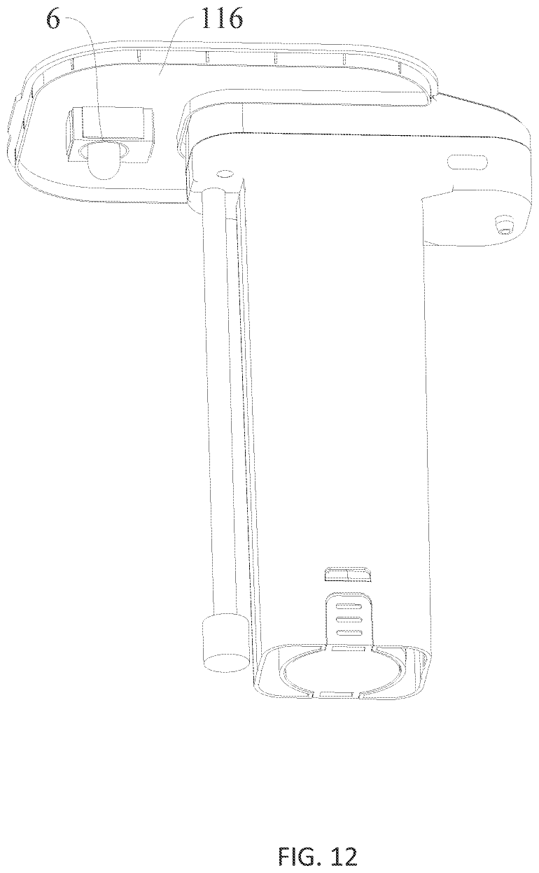

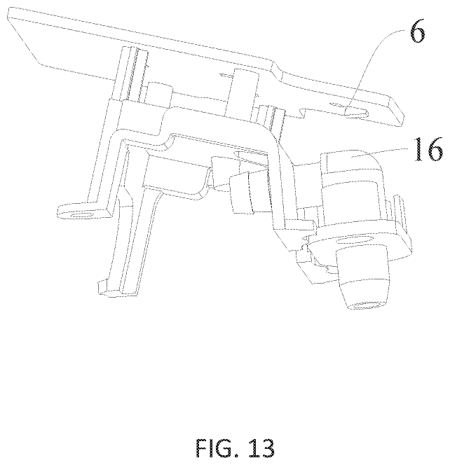

In some aspects, the water supply assembly includes a sterilization device 6. The sterilization device 6 sterilizes the water in the water supply line 1 to ensure the cleanliness and hygiene of the water outlet 12. The sterilization device 6 may be an ultraviolet sterilization device to kill bacteria and viruses in the water tank and avoid the growth of green algae. In FIG. 9, the sterilization device 6 is located on the water supply line 1 between the water outlet 12 and the filter element 100. However, the sterilization device 6 can also be located at other positions along the water supply line 1. For example, in FIG. 12, a sterilization device 6 may also be provided on the water tank cover 116 of the water tank. As another example, in FIG. 13, the sterilization device 6 is provided in the installation space between the water assembly housing 151 and the water assembly cover 155. In the configuration shown in FIG. 13, part of the water supply line 1 proximate the sterilization device 6 is transparent to enable the sterilization device 6 to kills bacteria and viruses in the water flowing through the water supply line 1.

Similarly, the sterilization device 6 may be located on the circuit board opposite to part of the water supply line 1. Again, the water supply line proximate the sterilization device 6 is a transparent part 16, thereby enabling the light of the sterilization device 6 to pass through the transparent part 16 to sterilize the water in the water supply line 1. Alternatively or additionally, antibacterial materials can also be added to the injection molded parts of the water tank, or antibacterial materials can be added to the filter element filter material to achieve the antibacterial effect.

In yet another example, the sterilization device 6 may be an overflow UV sterilization structure that is positioned directly on the water pump outlet 1522. Accordingly, UV sterilization can be carried out as water flows to the water outlet 12 after being filtered by the filter element 100 to remove microbial pollutants such as bacteria (Escherichia coli and Streptococcus glucose) and viruses in the water, and the sterilization rate can reach 99.9%.

Alternatively, a sterilization device 6 can be installed in the water tank 114 of the water purifier. The sterilization device 6 can include a rechargeable UV sterilization lamp, a polymer battery, and a power supply board. The sterilization device may be charged through a Type-C data cable or another suitable charging method. The sterilization device fixed between setting ribs on the water tank 114 or the cover of the water tank, although other methods for positioning the sterilization device are contemplated and possible. The sterilization device can be directly removed for charging and reinstalled for use after charging is completed.

In any of the aspects described herein, the sterilization device can be adjusted. For example, the angle of the UV sterilization lamp of the static sterilization device can be adjusted, and different powers, lamp beads, and irradiation angles can be configured according to the shape and capacity of the water tank. In some aspects, the working time of the UV sterilization lamp can be set through the control panel to effectively kill bacteria and viruses in the water and prevent the growth of green algae.

### Water Purifiers

In various aspects of the disclosure, any of the water supply assemblies described hereinabove can be incorporated into a water purifier such as, for example, any of the water purifiers described hereinbelow. The water purifiers may be in the form of a counter-top purification system, a portable pitcher or kettle, a water purification bottle, or the like.

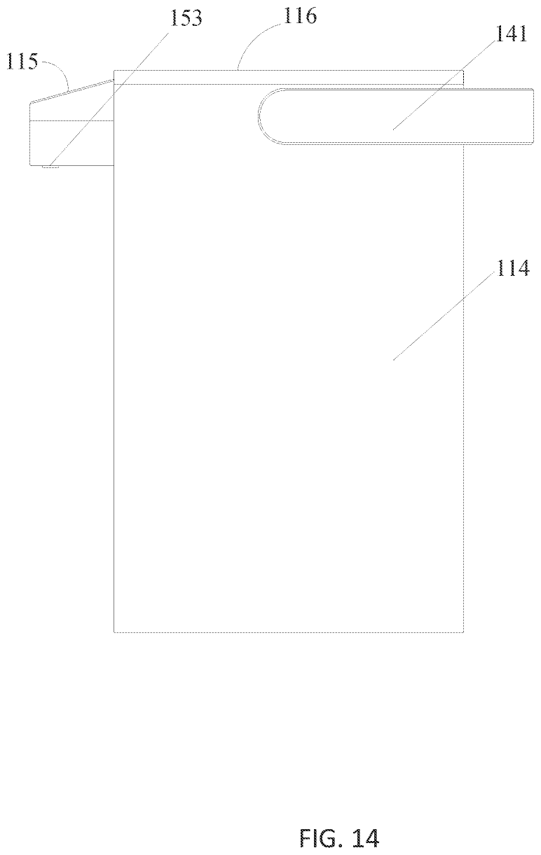

As shown in FIGS. 14 and 15, a water purifier includes a water tank 114 and a water supply assembly 115. The water tank 114 is used to accommodate raw water, and the water supply assembly 115 is used to purify the raw water in the water tank 114. The purified water flows out of the water outlet 12. The water supply assembly 115 is at least partially located in the water tank 114. In particular, the water tank 114 includes an installation part, which is detachably coupled to the water supply assembly, and an accommodating part, which is configured to hold the raw water. The installation and accommodation parts of the water tank 114 may be defined within the water tank 114 through a partition plate, or the accommodation part can be the internal cavity of the water tank, and the installation part can be an installation cavity of the upper water component formed outside of the water tank 114 through the enclosure plate. In other aspects, the installation part can be the installation structure on the water tank, and the water supply assembly and the water tank can be coupled through plug-in fit, hook connection, snap fit, etc. As shown in FIGS. 14 and 15, the water purifier also includes a water tank cover 116, which covers the upper opening of the water tank 114 and at least partially covers the top of the water supply assembly 115.

The water purifier is provided with a handle 141, and a special-shaped hole (not shown) for receiving the handle is provided on the side wall of the water tank 114. The special-shaped hole receives the handle 141 to couple the handle 141 to the water purifier and limit the rotation of the handle 141.

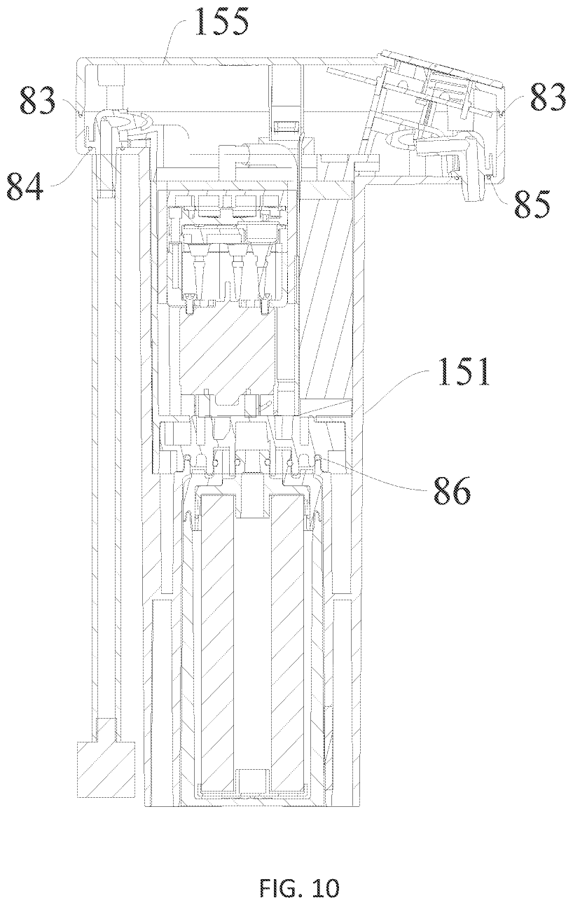

One or more seals may be included to create a water-tight interface between adjacent components. As shown in FIG. 10, the water pump 152, the filter element 100, and the sterilization device 6 are all located in a water assembly housing 151, and a water assembly cover 155 is used to close the top of the water assembly housing 151. In aspects, a first sealing element 83 is provided between the water assembly cover 155 and the water assembly housing 151 to provide a seal. In some aspects, part of the first upper water pipe section 13 of the water supply line 1 extends from the water assembly housing 151, and the part where the first upper water pipe section 13 of the water supply line 1 is assembled with the water assembly housing 151 is sealed by the second sealing element 84. In some aspects of the disclosure, the water outlet 12 extends from the water assembly housing 151, and the part where the water outlet end is assembled with the water assembly housing 151 is sealed by the third sealing element 85. In some aspects, the fitting part of the joint of the filter element 100 and the inner wall of the water assembly housing 151 is sealed by the fourth sealing element 86.

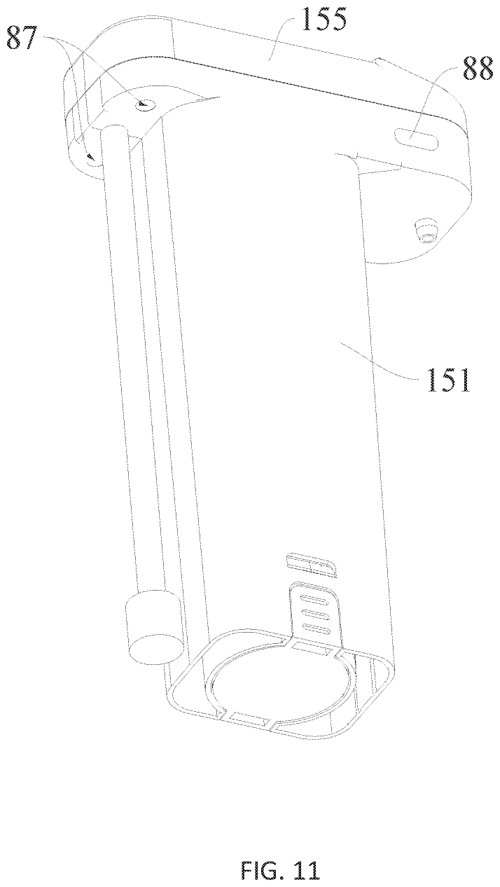

As shown in FIG. 11, a first silicone plug 87 is provided at the assembly threaded hole of the water assembly housing 151, and a second silicone plug 88 is provided at the charging interface of the water assembly housing 151. The first and second silicone plugs seal and protect the electronic devices in the water assembly housing 151 and the water assembly cover 155.

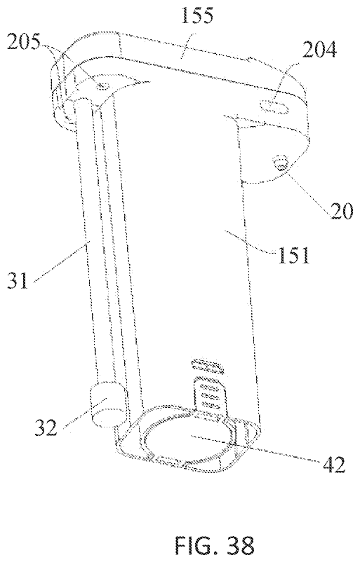

Additionally, as shown in FIG. 34, a power supply 270 may be located in the water assembly housing 151 to supply power to the water pump 152. In aspects, a charging hole is also provided on the water assembly housing 151, and the power supply 270 and the water pump 152 can be electrically connected to an external power source through the charging hole. Accordingly, a fourth sealing member 204 may be provided to block the charging hole. As shown in FIG. 38, the water supply assembly further includes a fifth sealing member 205, which is used to seal the bolt hole connected to the water assembly housing 151 and the water assembly cover 155.

In various aspects provided herein, the one or more sealing members (e.g., the first sealing member 201, second sealing member 202, third sealing member 203, fourth sealing member 204, fifth sealing member 205, etc.) can provide a waterproof seal to separate the internal electrical components from the water supply assembly, thereby preventing a short circuit from affecting the normal use of the water supply assembly.

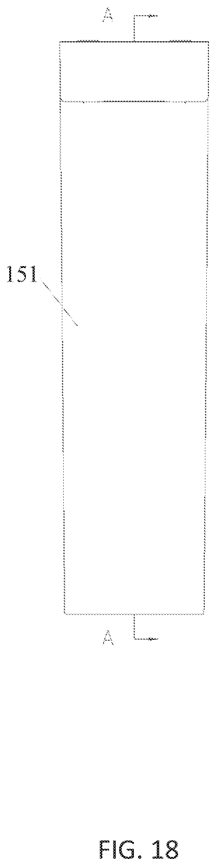

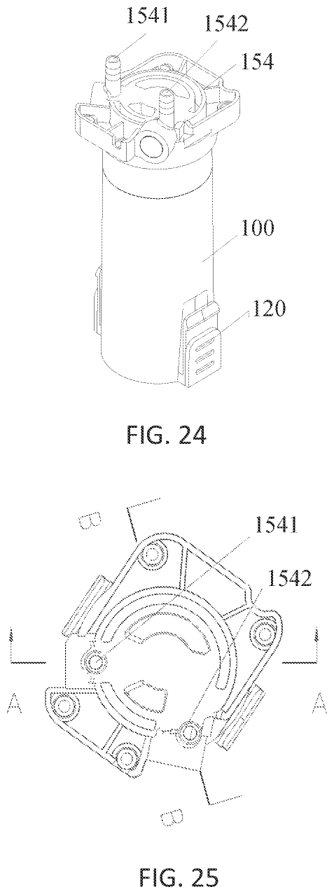

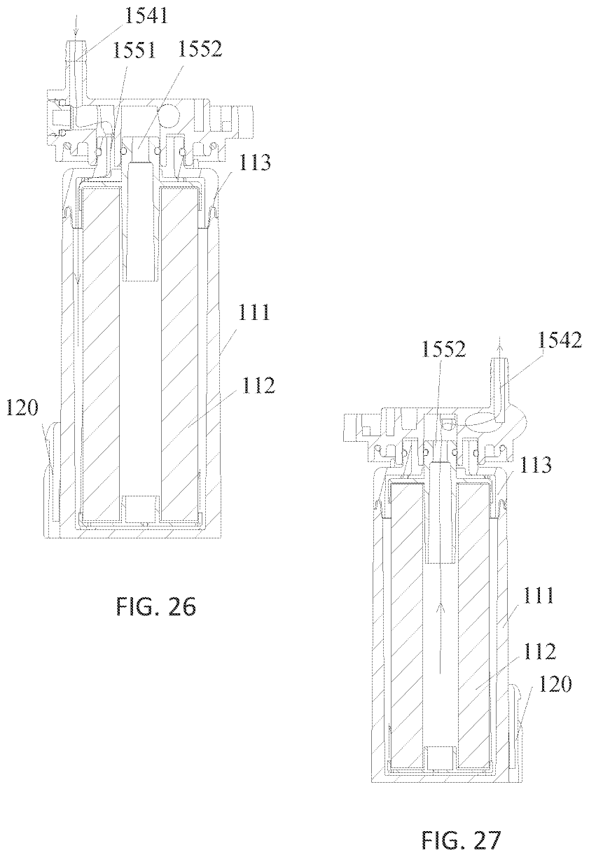

As shown in FIGS. 16-28, the water supply assembly 115 includes a water assembly housing 151, a water assembly cover 155, a water inlet 156, a water outlet 12, a water pump 152, and a filtration module. The water pump 152 is fluidly coupled to the water pump inlet 1521 and the water pump outlet 1522. In aspects, one end of the water pump 152 has a water pump end cover (not shown). Water flows in through the water pump inlet 1521, the water pump 152, and out through the water pump outlet 1522. The water pump is located in the water assembly housing 151 along with the filter module.

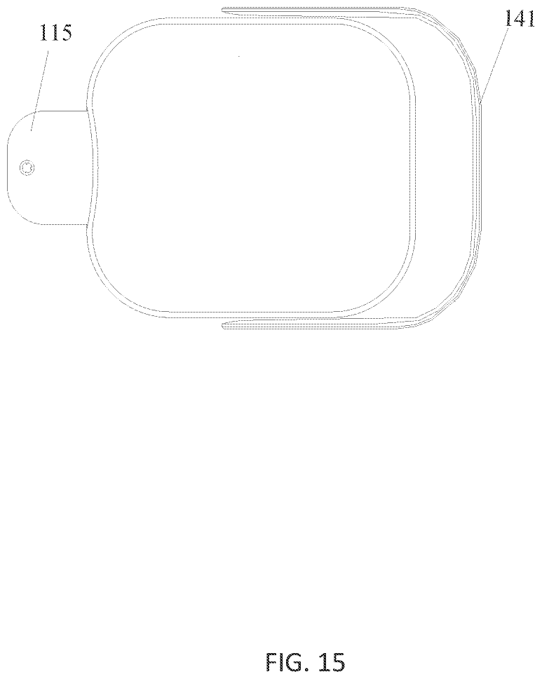

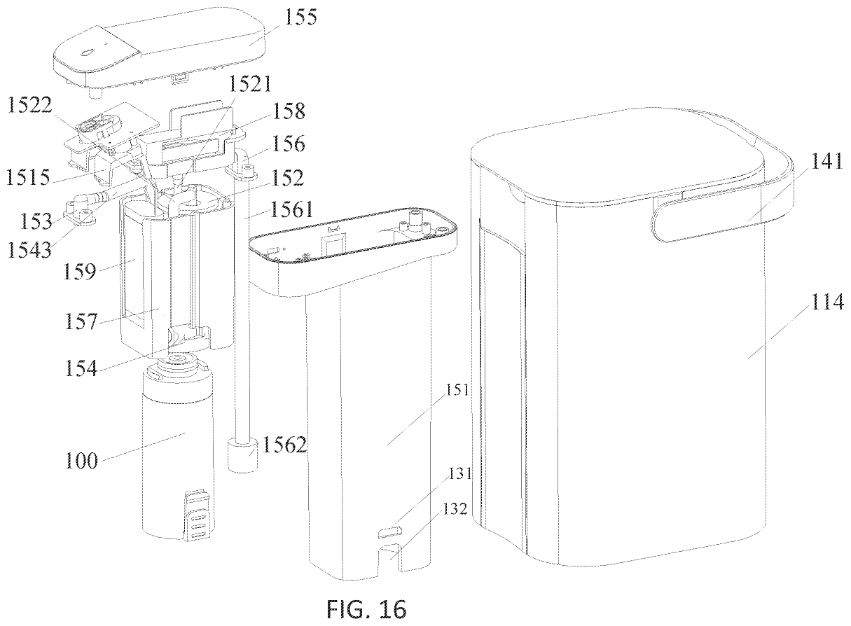

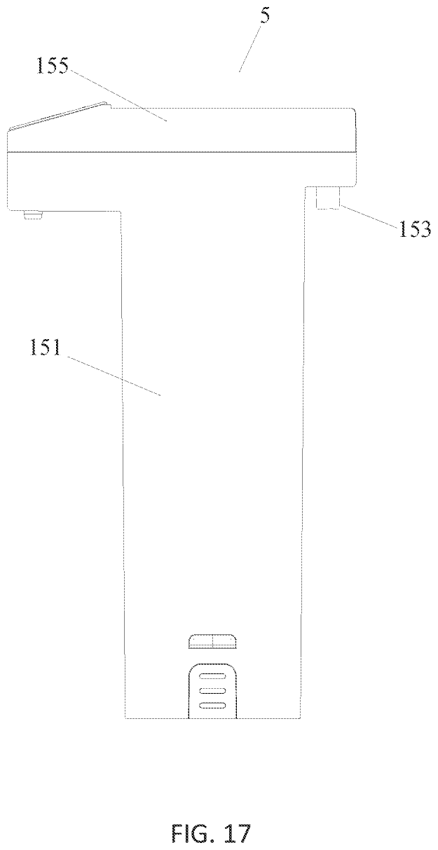

As shown in FIGS. 17, 35, and 36, in various aspects, the water assembly housing 151 has an overall “T” shape, and the water outlet 12 and the water inlet 156 are located at opposing ends of the horizontal portion of the “T”. However, other shapes for the water assembly housing 151 are contemplated and possible, and the water purifiers are not limited to those having a “T” shape.

The filter module receives water from the water pump outlet 1522. The outlet of the filter module is connected to the water outlet 12. The filter module includes a filter element connector 154 and a filter element 100. The filter element connector 154 is installed in the water assembly housing 151, and the filter element 100 is detachably installed in the water assembly housing 151 and connected to the filter element connector 154.

In aspects of the disclosure, the water pump and the filter module are stacked and the water pump is located above the filter module within the water assembly housing 151. The filter element connector 154 is set below the water pump, and the filter element 100 is connected to the side away from the water pump of the filter element connector 154. The water assembly cover 155 of the water assembly housing 151 is used to close the top of the water assembly housing 151. There is a cooperating latching structure between the water assembly cover 155 and the water assembly housing 151. During assembly, the latching structure on the water assembly cover 155 is correspondingly matched with the latching structure on the water assembly housing 151 to fix the water assembly cover 155 to the water assembly housing 151.

The water pump 152 and the filter element connector 154 are fixedly installed in the water assembly housing 151, and the filter element 100 is detachably installed in the water assembly housing 151 from the bottom of the water assembly housing 151. When the filter element 100 is installed in the water assembly housing 151, it is connected to the filter element connector 154.

The end cap of the water pump is located at the end of the water pump away from the filter element connector 154. In order to avoid excessive bending angle of the water pump outlet 1522, the end cap of the water pump may be designed with an elbow outlet.

In aspects, the water pump inlet 1521 is fluidly coupled to the water inlet 156, which is fixedly installed on the inlet nozzle bolt column 1511 of the water assembly housing 151. The water inlet 156 is connected to the suction pipe 1561, and a filter head 1562 is provided at the inlet end of the suction pipe 1561. The filter head 1562 may be positioned proximate to the bottom of the water tank 114 used to filter large particle impurities from the raw water.

The filter element connector 154 includes a filter element connector inlet 1541 and a filter element connector outlet 1542. The filter element connector inlet 1541 is connected to the water pump outlet 1522, which is also the filter element inlet pipe. The filter element connector outlet 1542 is connected to the water outlet 12. Specifically, the filter element connector outlet 1542 is connected to the water outlet 12 through the filter element outlet pipe 1543, and the water outlet 12 is fixedly installed on the outlet nozzle bolt column 1514 of the water assembly housing 151.

In various aspects, the water outlet 12 may be equipped with several water outlet tendons to ensure smooth water flow and prevent splashing. The water outlet tendons are arranged parallel to the axis of the water outlet 12, generally four of which are evenly distributed within the water outlet 12.

The filter element 100 includes a filter element inlet 1551 and a filter element outlet 1552. When the filter element 100 is installed on the water assembly housing 151, the filter element 100 is connected to the filter element connector 154. Specifically, the filter element inlet 1551 is connected to the filter element connector inlet 1541, and the filter element outlet 1552 is connected to the filter element connector outlet 1542 to form a complete waterway structure.

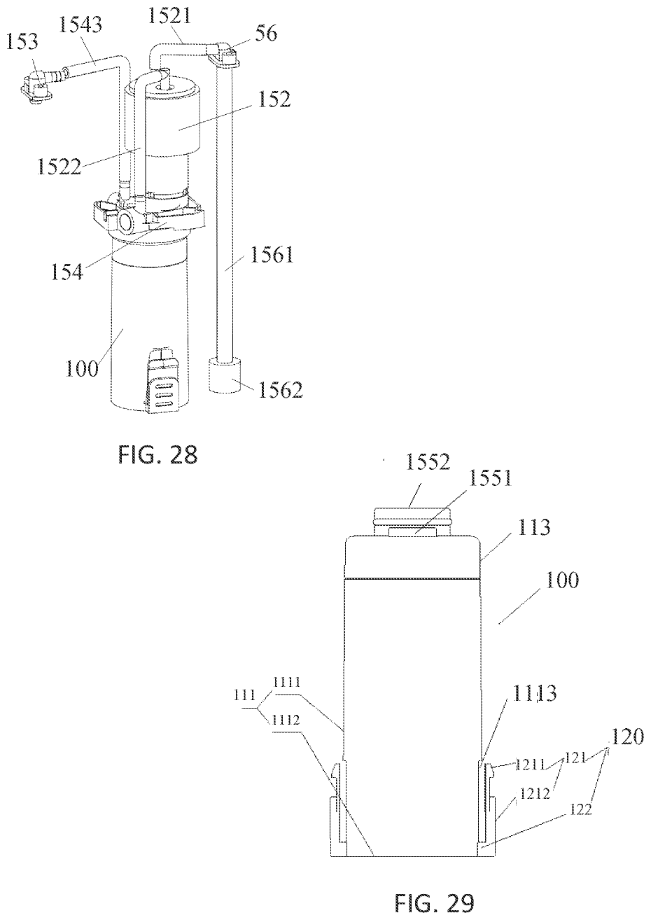

As shown in FIGS. 16 and 28, when the water pump 152 is working, the raw water in the water tank 114 passes through the filter head 1562, the suction pipe 1561, the water inlet 156, the water pump inlet 1521, the water pump 152, the water pump outlet 1522, the filter element connector inlet 1541, the filter element 100, the filter element connector outlet 1542, and the filter element outlet pipe 1543, in sequence, under the action of the water pump 152, and then flows out as clean water from the water outlet 12. Accordingly, in aspects, the filter element is located on the head of the water pump, and water is sent into the filter element through the head of the water pump. In contrast, in conventional water purifiers, the raw water first passes through the filter element and then is pumped out by the water pump. As such, the water path system of various aspects described herein use the head of the water pump to send water to the filter element, thereby enabling a faster flow rate, higher filtration efficiency, and faster water output speed as compared to conventional systems.

In any of the aspects herein, the water pump 152 may also include a fixing member 157. The fixing member 157 is configured to couple with the filter element connector 154 and the water pump 152, so that the filter element connector 154 and the water pump 152 can be installed in the water assembly housing 151 as a single unit. Similarly, when disassembled, the filter element connector 154, the water pump 152, and the fixing member 157 can be taken out as a unit, and the installation and disassembly are simplified as compared to conventional systems. In particular, the fixing member 157 includes a water pump accommodating chamber 1571 in which the water pump 152 is positioned.

Specifically, as shown in FIGS. 21-23, the top of the fixing member 157 is provided with a water pump accommodating chamber 1571, and several protrusions 15711 are provided on the side wall of the water pump accommodating chamber 1571 to properly position the water pump 152. The filter element connector 154 is fixedly installed at the bottom end of the fixing member 157. The bottom end of the fixing member 157 can also be provided with a filter element connector accommodating groove 1572 (FIG. 23), and the filter element connector 154 is fixedly installed in the filter element connector accommodating groove 1572. A filter element connector bolt 1573 is provided at the bottom of the filter element connector accommodating groove 1572 or the bottom end of the fixing member 157 to facilitate the installation of the filter element connector 154. In addition, the fixing member 157 has a through hole through which the water pump outlet 1522 and the filter element outlet pipe 1543 pass.

In various aspects, the fixing member 157 may further include a battery accommodating chamber 1574 in which a battery 159 is located. The battery is electrically connected to the water pump 152, which can enhance the portability and mobility of the water purifier without the need to plug in AC power. In aspects, the water purifier can operate with or without an external power source. The battery 159 may be a rechargeable battery, and, in such implementations, a charging hole may be provided through the water assembly housing 151 to enable charging of the battery 159. By coupling the battery 159 to the fixing member 157, the battery 159 can be installed and removed as part of the unit including the fixing member 157, the water pump 152, and the filter element connector 154.

Furthermore, when the power supply 270 is short of power and needs to use the water supply assembly for water intake, an adapter can be used to connect the charging hole and external power supply to directly supply power to the water pump 152 to solve the need for emergency water intake. After the water intake is completed, the external power supply is turned to the power supply 270 for charging through the adapter. Therefore, the water supply assembly can be powered by the power supply module alone, or it can be used while plugging in when needed, which is convenient, fast, and practical.

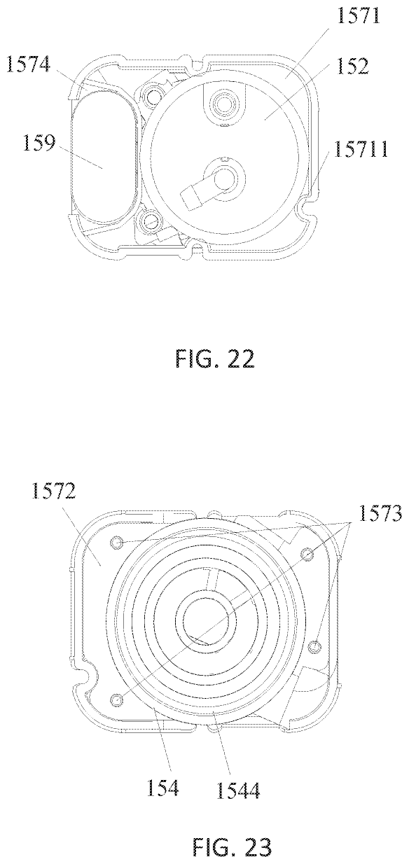

As shown in FIGS. 21 and 22, the battery accommodating chamber 1574 and the water pump accommodating chamber 1571 are arranged side by side. Accordingly, after the battery 159, the water pump 152, and the filter element connector 154 are installed on the fixing member 157, the battery 159 and the water pump 152 are arranged side by side above the filter element connector 154. Additionally, the battery accommodating chamber 1574 and the water pump accommodating chamber 1571 are divided by a baffle, so that the battery accommodating chamber 1574 and the water pump accommodating chamber 1571 can be adapted to the shapes of the battery 159 and the water pump 152, respectively, to facilitate assembly operations.

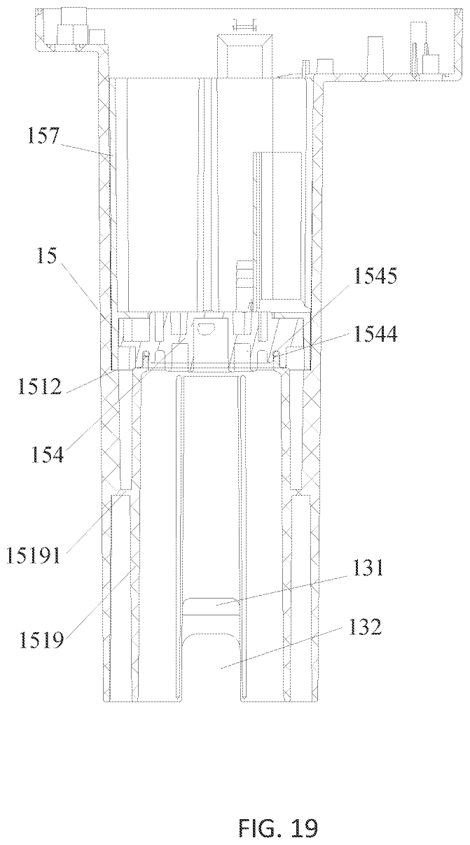

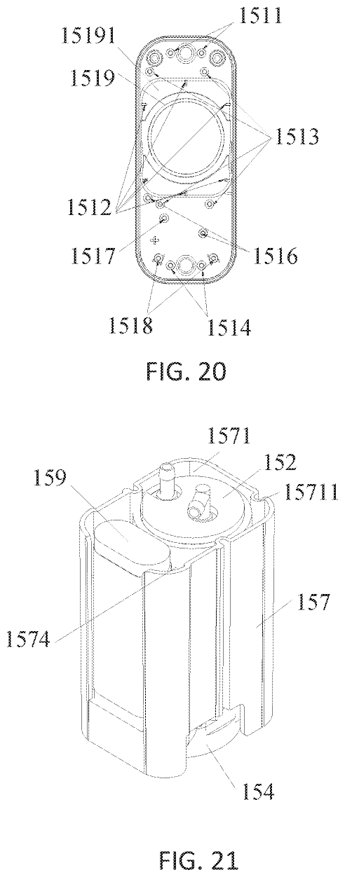

The water assembly housing 151 further includes a support portion 1512 configured to support the fixing member 157 when the fixing member 157 is placed in the water assembly housing 151. As shown in FIGS. 19 and 20, the support portion 1512 is a support rib extending inwardly from the inner wall of the water assembly housing 151, although other forms are possible and contemplated.

The water assembly housing 151 also includes a pressure plate 158 which presses the fixing member 157 against the support portion 1512 and presses the water pump 152 against the fixing member 157. Together, the pressure plate 158 and the support portion 1512 position the water pump within the water assembly housing 151 in the axial direction. The pressure plate 158 also presses the water pump 152 and the battery 159 together on the fixing member 157. A pressure plate bolt post 1513 is provided on the water assembly housing 151, and the pressure plate 158 is fixedly installed on the pressure plate bolt post 1513.

When a sterilization device is included in the water supply assembly, the sterilization device (not shown) may be provided between the filter element connector outlet 1542 and the water outlet 12. For example, the sterilization device may be provided on the filter element outlet pipe 1543 and may be installed between the two vertical plates at the top of the pressure plate 158 shown in FIG. 16.

A circuit board bracket 1515 is installed on the water assembly housing 151. The circuit board bracket 1515 is used to install a control module, which may be located above the water pump module in any of the aspects described herein. The control module is used to control the start and stop of the water pump 152, thereby controlling the discharge of water. The power board for managing the battery 159 may be installed on the water assembly housing 151 below the circuit board bracket 1515. The water assembly housing 151 includes circuit board bracket bolt posts 1516 for coupling the water assembly housing 151 to the circuit board bracket 1515 and power board bolt posts 1517 for coupling the water assembly housing 151 to the power board.

As shown in FIGS. 19 and 20, a filter element connector support portion 1519 is provided in the water assembly housing 151. The filter element connector support portion 1519 is connected to the filter element connector 154 and supports the filter element connector 154. The inner wall shape of the filter element connector support portion 1519 may be adapted to the outer wall shape of the filter element 100 and can also guide the filter element 100 into and out of position within the water assembly housing 151. In aspects of the disclosure, the filter element connector support portion 1519 includes a cylindrical portion and is connected to the inner wall of the water assembly housing 151 through two 15191 connection portions.

The filter element connector 154 has an annular groove 1544 that cooperates with the filter element connector support portion 1519. A sealing ring 1545 is provided in the annular groove 1544. Accordingly, the top of the cylinder portion of the filter element connector support portion 1519 is positioned within the annular groove 1544 and the sealing ring 1545 between the filter element connector support portion 1519 and the filter element connector 154 may prevent residual water from entering the components above the filter element connector 154 during, for example, the disassembly process of the filter element 100. Accordingly, damage to the electronic devices and circuits above the filter element connector 154 can be reduced or prevented.

The bottom of the water assembly housing 151 is open to enable the filter element 100 to be inserted into the water assembly housing 151. In aspects, the filter element 100 may be snap-connected to the water assembly housing 151 or threaded to the filter element connector 154 to fix the filter element 100 within the water assembly housing 151. As shown in FIGS. 29, 30, and 33, the filter element 100 of various aspects includes a filter element housing 111 and a filter element body 112 located within the filter element housing 111. In aspects, the filter element body 112 is a carbon rod, although other filtration materials are possible and contemplated. The filter element housing 111 is generally cylindrical and includes side walls 1111 and end portions located at both ends of the side walls 1111. One end portion of the filter element housing 111 is a closed end 1112, and the other end is open. The filter element housing 111 includes a cartridge cover 113, and the open end is fitted to the cartridge cover 113.

The filter element housing 111 forms a space for accommodating the filter element body 112. Additionally, a raw water space is formed between the outer surface of the filter element body 112 and the inner surface of the side wall 1111 of the filter element housing 111. In various aspects, the raw water space is in fluid communication with the filter element inlet 1551, such that water flows in through the filter element inlet 1551, into the raw water space, and through the filter element body 112. The central hole of the filter element body 112 is in fluid communication with the filter element outlet 1552, such that water flows in through the filter element body 112, through the central hole of the filter element body 112, and out through the filter element outlet 1552.

Generally, the filter element 100 has a certain lifespan. In order to facilitate the installation and removal of the filter element 100, a latching member 120 is provided on the filter element housing 111, and a second latching structure 1311 that cooperates with the latching member 120 is provided on the water assembly housing 151. The latching member 120 is assembled with the second latching structure 1311, which is convenient and fast. When the latching member 120 is coupled with the second latching structure 1311, the filter element 100 is connected to the filter element connector 154, the filter element inlet 1551 is connected to the filter element connector inlet 1541, and the filter element outlet 1552 is connected to the filter element connector outlet 1542.

The latching member 120 includes a latching portion 121 including a first latching structure 1211. In aspects, the latching portion 121 and the side wall of the filter element housing 111 are spaced apart such that the latching portion 121 can be offset and reset in the direction of the side wall 1111 of the filter element housing 111. The latching portion 121 is formed from a material having a certain hardness and capable of a certain amount of deformation while returning to its original position following deformation. The first latching structure 1211 of the present embodiment is provided as a claw, although the first latching structure 1211 may alternatively be provided as a card block, slot, card hole, or other form of latching.

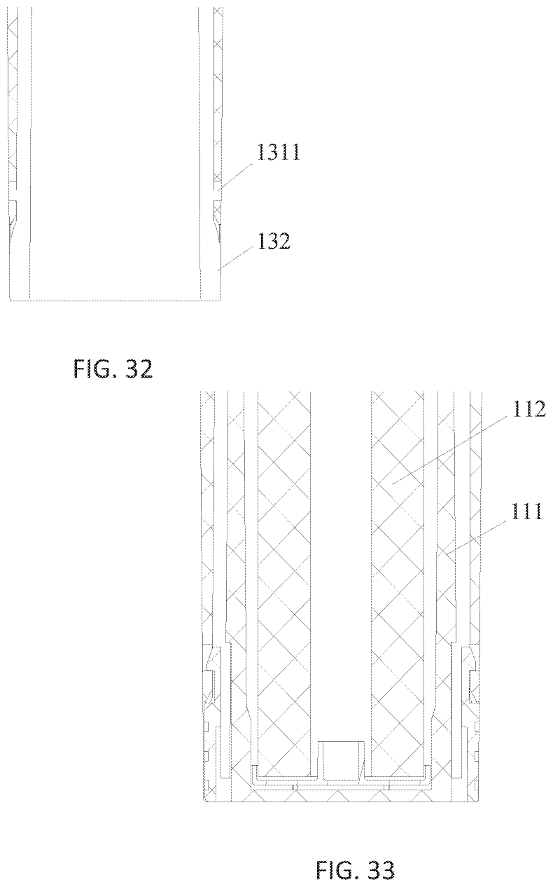

Correspondingly, as shown in FIGS. 31 and 32, a second latching structure 1311 adapted to the first latching structure 1211 is provided on the water assembly housing 151. In various aspects, when the filter element 100 is installed in the water assembly housing 151, the closed end 1112 of the filter element 100 is flush with the bottom of the water assembly housing 151. Accordingly, the second latching structure 1311 is located near the bottom on the inner wall of the water assembly housing 151. When the first latching structure 1211 is matched with the second latching structure 1311, the filter element 100 is fixed in place within the water assembly housing 151. When the first latching structure 1211 is set as a claw or block, the second latching structure 1311 is set as a slot or hole, and when the first latching structure 1211 is set as a slot or hole, the second latching structure 1311 is set as a claw or block.

In order to facilitate the installation of the filter element, the extension direction of the latching portion 121 is roughly the same as the extension direction of the side wall 1111 of the filter element housing 111. Therefore, the latching member 120 may further include a connecting portion 122, which is used to couple the latching portion 121 to the filter element housing 111. In aspects, the connecting portion 122 and the latching portion 121 are arranged at a certain angle. For example, the connecting portion 122 may be provided at a 90-degree angle to the side wall 1111, and the connecting portion 122 may be provided at a 90-degree angle to the latching portion 121. The connecting portion 122 may be formed from a hard material, or the connecting portion 122 may be a material having a certain hardness and capable of a certain amount of deformation.

The connecting portion 122 is provided on the side wall 1111 of the filter element housing 111 near the closed end 1112 of the filter element housing 111. In aspects, the bottom of the connecting portion 122 may be flush with the end portion of the filter element housing 111, which may reduce the contact stroke between the latching member 120 and the filter element assembly during the installation process of the filter element 100, facilitate installation, reduce installation force, reduce the deformation time of the latching member 120, and avoid deformation and damage of the latching member 120.

Due to the addition of the latching member 120 on the filter element housing 111, the volume of the filter element 100 is inevitably increased. Accordingly, a concession groove 1113 may be provided on the filter element housing 111 proximate the latching member 120. The connecting portion 122 is partially located in the concession groove 1113. When the latching portion 121 deforms in the direction of the side wall 1111 of the filter element housing 111, the concession groove 1113 can make way for the latching portion 121.

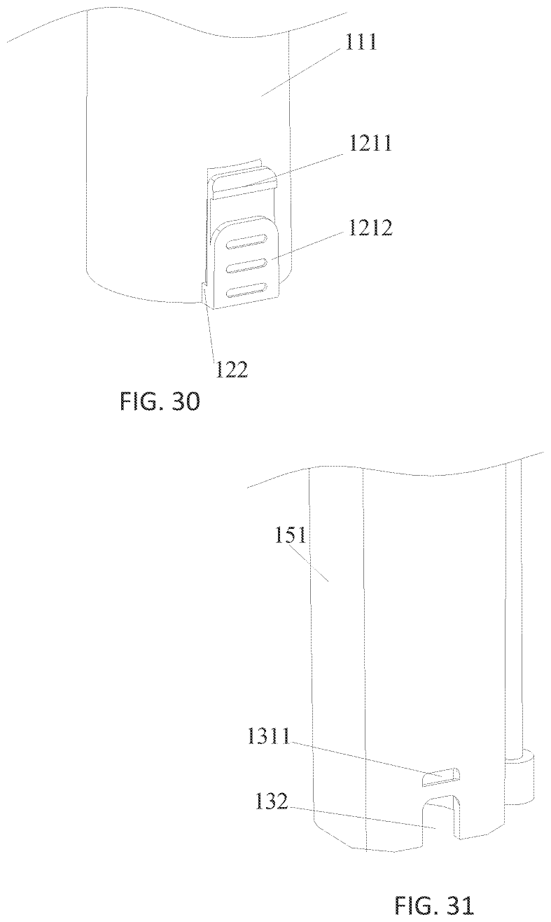

In aspects, the filter element 100 may be removed from its secured position using a tool to decouple the first latching structure 1211 and the second latching structure 1311. Additionally or alternatively, as shown in FIG. 30, a force application area 1212 may be provided on the latching portion 121 between the first latching structure 1211 and the connecting portion 122. In some aspects, several protrusions or grooves are provided on the force application area 1212 to increase the roughness of the force application area 1212 and aid in application of force to the force application area 1212, which may improve the success rate of force application and avoid difficulties associated with applying force to a smooth surface. Additionally, as shown in FIGS. 31 and 32, a notch groove 132 for exposing the force application area 1212 is provided on the water assembly housing 151. It is contemplated that the shape and form of the notch groove 132 can vary.

When a force is applied to the force application area 1212, the latching portion 121 deforms in the direction of the side wall 1111 of the filter element housing 111, causing the first latching structure 1211 to be decoupled from the second latching structure 1311, and the filter element 100 can be removed. Additionally, in some aspects, a force can be applied to the force application area 1212 during installation of the filter element 100, causing the latching portion 121 to deform in the direction of the side wall 1111 of the filter element housing 111. When in place, the force may be removed, the latching portion 121 is returned to its original position, and the first latching structure 1211 is coupled with the second latching structure 1311.

In any of the aspects herein, two latching members 120 may be provided on the filter element 100, and the two latching members 120 may be symmetrically arranged about the exterior surface of the filter element 100. Accordingly, when disassembling the filter element 100, only the force application area 1212 needs to be pinched and the filter element 100 can be pulled out. In aspects, the connecting portion 122 may be provided on the cartridge cover 113. For example, depending on the positional relationship between the latching portion 121 and the cartridge cover 113, the concession groove 1113 may be located entirely on the cartridge cover 113, entirely on the side wall 1111 of the housing body, or partially on the cartridge cover 113 and partially on the side wall 1111 of the housing body.

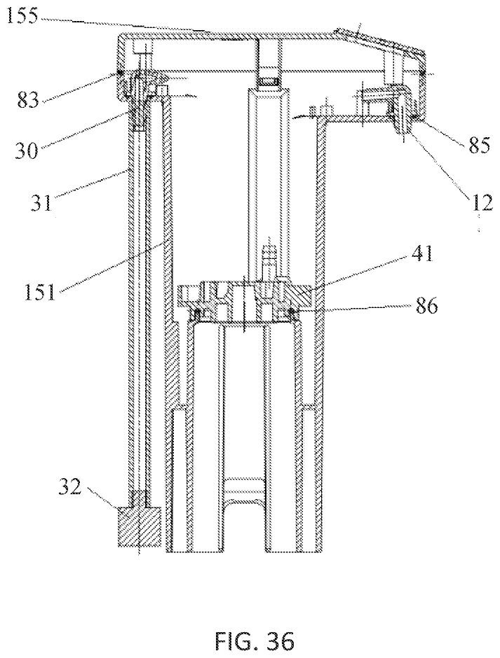

As shown in FIG. 36, the water supply assembly includes a water assembly housing 151 and a water assembly cover 155 provided on the water assembly housing 151, and the water assembly cover 155 and the water assembly housing 151 are sealed together by a first sealing member 201. A connector 241 is located within the water assembly housing 151 and is sealed and matched with the water assembly housing 151 through the second sealing member 202. A water outlet corresponding to the water outlet 12 is provided on the water assembly housing 151, and the outer wall surface of the water outlet 12 is sealed and matched with the third sealing member 203.

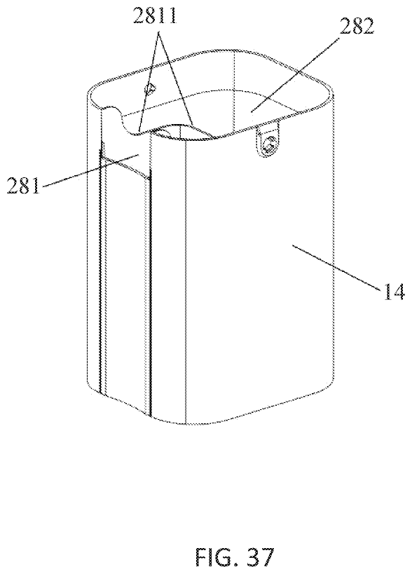

Turning now to FIG. 37, in aspects, the water tank 114 includes a mounting portion 281 and a receiving portion 282, the water supply assembly is detachably mounted to the mounting portion 281. The receiving portion 282 is used for water storage. The water inlet 156 is fluidly connected to the receiving portion 282 through the water inlet pipe 231.

Specifically, the mounting portion 281 and the receiving portion 282 are disposed within the interior of the water tank 114. When the water supply assembly is mounted to the mounting portion 281, the water outlet 12 extends to the outside of the water tank 114, so that the user can receive water. The water inlet 156 is positioned above the receiving portion 282, and the water inlet pipe 231 is connected to the water inlet 156 and extends into the bottom of the receiving portion 282 to take in water.

As shown in FIG. 37, the mounting portion 281 includes side walls 2811, the side wall 2811 and the inner wall of the water tank 114 enclose the mounting space of the water supply assembly, and the upper edge of the side wall 2811 and the upper edge of the inner wall of the water tank 114 are used to support the water supply assembly.

In FIG. 37, the mounting portion 281 is surrounded by multiple side walls 2811 and set in the water tank 114, and the internal space of the mounting portion 281 is adapted to the outer contour of the water supply assembly. When the water supply assembly is installed in the mounting portion 281, the upper edge of the side wall 2811 and the upper edge of the water tank 114 support the lower surface of the water supply assembly to support and stabilize the water supply assembly in the water tank 114.

Alternatively, the water supply assembly may be supported by the bottom of the water tank 114. For example, the water supply assembly may be positioned by an installation space defined by the side walls 2811 of the mounting portion 281 and the internal wall of the water tank 114 such that the side walls 2811 constrict the position of the water supply assembly in the circumferential direction, and the bottom of the water tank 114 constricts the position of the water supply assembly in the vertical direction to ensure that the water supply assembly is not reoriented during use.

1. A water purifier comprising:
a water tank comprising a mounting portion and a receiving portion for storing water;
a water supply assembly removably mounted to the mounting portion of the water tank, wherein the water supply assembly comprises:
a water inlet in fluid communication with the receiving portion of the water tank;
a water pump comprising a water pump inlet and a water pump outlet;
a filter element fluidly coupled to the water pump, wherein the filter element is positioned along a water flow path between the water outlet and the water pump outlet;
a water outlet positioned along the water flow path downstream of the water pump outlet; and
a water assembly housing in which the water pump and filter element are positioned.

2. The water purifier of claim 1, wherein the water inlet and the water outlet are disposed in an upper part of the water assembly housing.

3. The water purifier of claim 1, wherein the filter element is positioned below the water pump in the water assembly housing.

4. The water purifier of claim 1, further comprising a water tank cover positioned over an upper opening of the water tank and at least partially covering the water supply assembly.

5. The water purifier of claim 4, further comprising a sterilization device disposed on a lower surface of the water tank cover.

6. The water purifier of claim 1, wherein the mounting portion comprises side walls defining, with the water tank, a mounting space for the water supply assembly.

7. The water purifier of claim 6, wherein the water supply assembly is at least partially supported by the side walls.

8. The water purifier of claim 6, wherein the water supply assembly is at least partially supported by an edge of the water tank.

9. The water purifier of claim 6, wherein the water supply assembly is at least partially supported by a bottom of the water tank.

10. The water purifier of claim 1, further comprising a sterilization device.

11. A filter element for a water purifier comprising a filter element housing and a filter element body, wherein:
a latching member is provided on the filter element housing, the latching member comprising a latching portion having a first latching structure;
the latching portion and a side wall of the filter element housing define a gap therebetween; and
the latching portion can be offset and reset in a direction of the side wall of the filter element housing.

12. The filter element of claim 11, further comprising a concession groove on the filter element housing corresponding to the latching member.

13. The filter element of claim 11, wherein the latching member further comprises a connecting portion configured to couple the latching portion to the filter element housing.

14. The filter element of claim 13, wherein the connecting portion is provided on the side wall of the filter element housing near an end of the filter element housing.

15. A water supply assembly comprising:
a water assembly housing;
a water pump positioned within the water assembly housing and comprising a water pump inlet and a water pump outlet;
a water inlet and a water outlet; and
a filter element fluidly coupled to the water pump;
wherein the filter element is positioned within the water assembly housing along a water flow path between the water pump outlet and the water outlet and the water inlet is positioned along the water flow path upstream of the water pump inlet.

16. The water supply assembly of claim 15, wherein the water inlet and the water outlet are disposed in an upper part of the water assembly housing.

17. The water supply assembly of claim 16, wherein the filter element is snap-connected to the water assembly housing.

18. The water supply assembly of claim 15, wherein the water pump and the filter element are in a stacked configuration.

19. The water supply assembly of claim 15, further comprising a control module, wherein the control module is positioned above the water pump within the water assembly housing.

20. The water supply assembly of claim 15, further comprising a power supply configured to supply power to the water pump.
